(19) United States
(12) Patent Application Publication
(10) Pub. No.: US 2021/0078107 A1
(43) Pub. Date: Mar. 18, 2021

(54) REACTIVE ADDITIVE MANUFACTURING OF METALLIC MATRIX COMPOSITES WITH CERAMICS

(71) Applicant: The Johns Hopkins University, Baltimore, MD (US)

(72) Inventors: Steven M. Storck, Timonium, MD (US); Ian D. McCue, Washington, DC (US); Michael C. Brupbacher, Catonsville, MD (US); Rengaswamy Srinivasan, Ellicott City, MD (US)

(21) Appl. No.: 17/012,228

(22) Filed: Sep. 4, 2020

Related U.S. Application Data
(60) Provisional application No. 62/899,435, filed on Sep. 12, 2019.

(51) Int. Cl. B23K 26/342; B33Y 10/00; B33Y 80/00; B33Y 70/10; B28B 1/00; B23K 26/00; B23K 26/08

(52) U.S. Cl. CPC B23K 26/342; B33Y 10/00; B33Y 80/00; B23K 2101/36; B28B 1/001; B23K 26/0006; B23K 26/08; B33Y 70/10

(57) ABSTRACT

Metal ceramic composites, or metallic matrix composites (MMCs), may be formed by additive manufacturing (AM) processing of powder beds including a plurality of metallic particles of one or more metals and a plurality of ceramic particles of one or more ceramic materials. The presence of the ceramic particles during the AM process changes the optical properties and/or thermal conductivity of the powder bed since the ceramic particles have markedly different optical properties and/or thermal conductivity relative to metal particles. These optical properties and/or thermal conductivities of the ceramic particles can be tailored in different areas within a given layer of the powder bed to change energy absorption of an energy beam in the different areas. The resulting MMCs exhibit significantly improved performance characteristics, including increases in strength properties, while maintaining ductility and improvement of resistance to pitting and crevice corrosion, among others characteristics.

### CROSS-REFERENCE TO RELATED APPLICATIONS

This application claims the benefit of U.S. Provisional Patent Application Ser. No. 62/899,435, filed on Sep. 12, 2019, which is expressly incorporated by reference herein in its entirety.

### BACKGROUND

The present disclosure is generally directed to additive manufacturing, and more particularly, to reactive additive manufacturing of ceramic-metal powder mixtures to provide three-dimensional (3D) metallic matrix composite articles having improved properties such as strength properties, corrosion resistant/inhibiting properties, hardness properties, and the like throughout the bulk (e.g., the three-dimensional volume) of the article.

Metallic matrix composites (MMC) are composite materials including at least two constituent components with one component being a metal and the other component being a ceramic or an organic compound or an intermetallic. When properly designed, MMCs meld the best physical properties of metals (high ductility, work hardening rates, and conductivity) with those of ceramics (high stiffness, strength, and low density). These property combinations can yield materials that operate in regions of Gibson-Ashby charts (e.g., high specific strength and conductivity) that are unattainable with conventional metallic or ceramic materials alone. However, despite their disruptive potential, the major impediment to their widespread use is synthesis and processing.

It is exceedingly difficult to use traditional manufacturing methods to synthesize MMCs at any fabrication stage: uniformly dispersing a ceramic phase into a molten metal matrix (e.g., stir casting) is notoriously challenging and becomes worse with increasing ceramic volume fraction; metal/ceramic interfaces tend to be incoherent and weak unless carefully grown via physical vapor deposition; and it is near-impossible to post-process machine and thermo-mechanically work MMCs because metals and ceramics have such disparate properties. Because of these significant impediments, three-dimensional structures formed of MMCs have been very slow to be adopted because they are difficult to reproducibly manufacture especially with structures exhibiting complex geometries. Current processes typically need specially designed molds, carefully controlled heat treatments, and cannot produce three dimensional articles having complex geometries.

### BRIEF SUMMARY

Disclosed herein are additive manufacturing processes and metal-ceramic composites. In one or more embodiments, an additive manufacturing process for producing a three-dimensional article includes providing a layer of feedstock including a plurality of metallic particles of one or more metals and a plurality of ceramic particles of one or more ceramic materials. The layer of the feedstock is exposed to an energy beam in a pattern to form a metal-ceramic composite in the pattern, wherein forming the metal-ceramic composite includes tailoring optical properties of the feedstock in different areas within the layer to change energy absorption of the energy beam by the feedstock in the different areas. At least one additional layer of the feedstock is deposited and the exposing is repeated on the at least one additional layer to form the three-dimensional article.

In one or more embodiments, the additive manufacturing process for producing a three-dimensional article includes providing a layer of feedstock including a plurality of metallic particles of one or more metals and a plurality of ceramic particles of one or more ceramic materials. The layer of the feedstock is exposed to an energy beam in a pattern to form a metal-ceramic composite in the pattern, wherein forming the metal-ceramic composite includes tailoring heat flow in different areas of the layer by changing thermal conductivity of the ceramic particles therein to enable an increase or a decrease in a cooling rate in the different areas. At least one additional layer of the feedstock is deposited and the exposing is repeated on the at least one additional layer to form the three-dimensional article.

A metal-ceramic matrix composite includes a metal, a ceramic, and a reaction zone between the metal and a ceramic particle, wherein the reaction zone comprises nitrides, borides, carbides, oxides, silicides or combinations thereof of the metal having a different composition than the ceramic.

Additional features and advantages are realized through the techniques of the embodiments of the present invention. Other embodiments and aspects of the invention are described in detail herein and are considered a part of the claimed invention. For a better understanding of the embodiments of the invention with advantages and features, refer to the description and to the drawings.

### BRIEF DESCRIPTION OF THE DRAWINGS

Example embodiments of the invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 is a process flow diagram of a reactive additive manufacturing (AM) process of a powder bed including metal particles and ceramic particles in accordance with one or more embodiments of the present invention;

FIG. 2 illustrates formation of a reaction zone within a metal matrix composite type 316L steel upon subjecting a layer of powder including metal particles and silicon carbide ceramic particles in accordance with one or more embodiments of the present invention;

FIG. 3 is a micrograph of a MMC-type 316L steel with ceramic particles formed by additive manufacturing illustrating the steel matrix, silicon carbide ceramic particle, and the reaction zone about the silicon carbide particle in accordance with one or more embodiments of the present invention;

FIG. 4 graphically illustrates porosity as a function of laser power for an AM processed type 316L steel without ceramic particles and an AM processed MMC-type 316L steel with ceramic particles in accordance with one or more embodiments of the present invention;

FIG. 5 graphically illustrates stress as a function of strain for a cast type 316L steel, an AM processed type 316L steel without ceramic particles and an AM processed MMC-type 316L steel with ceramic particles in accordance with one or more embodiments of the present invention;

FIG. 6 graphically illustrates current response as a function of time for an applied electrochemical potential on AM processed 316L steel without ceramic particles and AM processed MMC-type 316L steel with ceramic particles immersed in simulated seawater, and before and after micrographs depicting surface corrosion in accordance with one or more embodiments of the present invention;

FIG. 7 are micrographs of an AM processed MMC-type 316L steel with silicon carbide depicting the reaction zone and elemental composition within selected areas of the reaction zone in accordance with one or more embodiments of the present invention;

FIG. 8 pictorially illustrate images from in situ thermal monitoring during additive manufacturing of a type 316L steel without ceramic particles and a MMC-type 316L steel with ceramic particles in accordance with one or more embodiments of the present invention;

FIG. 9 graphically illustrates strength and elongation to failure properties for type 316L steels without ceramic particles and a MMC-type 316L steels with ceramic particles formed by additive manufacturing in accordance with one or more embodiments of the present invention;

FIG. 10 graphically illustrates frequency percentage as a function of equivalent grain diameter for AM processed type 316L steels without ceramic particles and AM processed MMC-type 316L steels with 5% silicon carbide particles in accordance with one or more embodiments of the present invention;

FIG. 11 graphically illustrates frequency percentage as a function of aspect ratio for AM processed type 316L steels without ceramic particles and AM processed MMC-type 316L steels with 5% silicon carbide particles in accordance with one or more embodiments of the present invention;

FIG. 12 are micrographs depicting surface corrosion of AM processed type 316L steels without ceramic particles compared to AM processed MMC-type 316L steels in accordance with one or more embodiments of the present invention;

FIG. 13 graphically illustrates strength and elongation properties for AM processed type 316L steels without ceramic particles and AM processed MMC-type 316L steels with ceramic particles using a pulsed laser additive manufacturing system and a continuous laser additive manufacturing system in accordance with one or more embodiments of the present invention;

FIG. 14 pictorially illustrates a metal build produced by additive manufacturing including a z-directional gradient of aluminum and aluminum with ceramic particles (MMC-Al) in accordance with one or more embodiments of the present invention;

FIG. 15 graphically illustrates Vickers Hardness and porosity percentage as a function of gradient zone of the metal build produced by selective laser melt additive manufacturing including the z-directional gradient of aluminum and MMC-Al in accordance with one or more embodiments of the present invention; and

FIG. 16 graphically illustrates Vickers Hardness across gradient zones 4 and 5 as a function of the distance from the zone boundary of the metal build produced by selective laser melt additive manufacturing including the z-directional gradient of aluminum and MMC-Al in accordance with one or more embodiments of the present invention.

### DETAILED DESCRIPTION

The present disclosure is generally directed to reactive additive manufacturing (AM) processes for forming three-dimensional structures of metallic matrix composites (MMCs). In one or more embodiments, the MMC three-dimensional structures are formed from a powder bed including metal particles and ceramic particles or from a wire feedstock including one or more metals and one or more ceramics. More particularly, the reactive additive manufacturing process includes a selective energy beam melting AM process using a laser energy beam or E-beam for sequentially forming the three-dimensional structure layer-by-layer. Unlike the use of dies or molds for producing relatively simple shapes, it has been discovered that AM processes of the present disclosure can be used to directly synthesize MMCs into complex geometries, which removes many of the limitations hindering adoption of these materials. Moreover, as will be described in greater detail herein. AM processing using selective energy beam synthesis of powder beds including metal particles and ceramic particles or wire feedstocks including one or more metals and one or more ceramics can be used to provide unique MMC structures that are only possible with AM. In conventional solid-state manufacture of MMCs, a blend of the metal and the ceramic are typically diffusion bonded in a particular arrangement and then pressed at an elevated temperature or sintered in which a powder of a matrix metal is mixed with a powder of the dispersed phase and heated at a temperature close to the melting point of the metal. In contrast, the AM process of the present disclosure can be used to provide reactive zones between a matrix metal and a dispersed ceramic phase.

In the AM process of the present disclosure, the ceramic particles can be dispersed in the metal powder matrix (or metal from wire feedstock in the event a wire process is utilized) and selected to increase energy transfer during the AM process. The presence of the ceramic particles during the AM process changes the optical properties and/or the thermal conductivity of the powder bed since the ceramic particles can be provided to have markedly different optical properties and/or thermal conductivities relative to metal particles. Likewise, the presence of the ceramic during melting of the wires can increase energy transfer during the AM process. Applicants have found that one or both of these properties can be tailored in different areas within a given layer to change energy absorption of the energy beam in the different areas. In this manner, ceramic reinforcement into metallic builds through reactive chemistry can produce MMCs or gradient materials that include MMCs that exhibit significantly improved performance characteristics of the three-dimensional structure including, but not limited to, increases in yield strength and tensile strength at room temperature and above while maintaining ductility, increases in creep resistance at higher temperatures compared to conventional alloys, increases in fatigue strength, improvement of thermal shock resistance, improvement of corrosion resistance, increases in Young's modulus, and reduction of thermal elongation, among other characteristics.

For convenience in understanding the present disclosure, reference will be made to powder bed feedstocks. However, it should be noted that the AM processes of wire feedstocks and the resulting benefits described herein for producing MMC metal builds is equally applicable. The optical properties of the ceramic particles can be selected to be reflective or absorbent of the input energy depending on the ceramic composition resulting in endothermic solidification or exothermic solidification or a combination of exothermic and endothermic solidification upon cooling. For endothermic reactions, limited local propagation of the reaction in adjacent areas may occur. For exothermic reactions, the heat will be conducted to adjacent regions and can propagate the reaction in these adjacent areas. By way of example, tungsten oxide ceramic particles having different oxidation states can be used in metal builds to manipulate laser energy absorption in different areas of the layer depending on the oxidation state to produce a different crystalline structures in selected areas of the metal build during the AM process. The different oxidation states provide different amounts of laser energy absorption based on the oxidation state. Advantageously, the presence of the ceramic particles in the powder bed can result in decreased amounts of laser energy (or E-beam) needed during the AM process to form the three-dimensional structure.

In a similar manner, the ceramic particles can provide a thermal conductivity that can be used to provide different crystalline structures within the composite. The ceramic particles can be selected to function as a heat sink or as a heat source to control the energy release into the metal matrix. As such, the thermal conductivity of the ceramic particles can be selected to have a greater or lesser thermal conductivity than the metal particles. As an example, a conventional metal powder bed used during selective laser metal AM manufacturing is prone to pore formation. In contrast, the ceramic particles dispersed throughout the metal powder bed can be selected to provide heat release during the selective laser melting AM process, which can prevent or minimize pore formation during solidification.

Conventional techniques related to AM processes for forming three-dimensional articles may or may not be described in detail herein. Moreover, the various tasks and process steps described herein can be incorporated into a more comprehensive procedure or process having additional steps or functionality not described in detail herein. In particular, various steps in the additive manufacture of three-dimensional articles are well known and so, in the interest of brevity, many conventional steps will only be mentioned briefly herein or will be omitted entirely without providing the well-known process details.

As used herein, the term “ceramic particles” refers to a solid material including an inorganic compound of a metal or metalloid and a non-metal with ionic or covalent bonds generally based on an oxide, nitride, boride or carbide. In one or more embodiments, the ceramic particles can range in size from about 0.01 μm to about 1000 μm; in one or more other embodiments, the ceramic particles can range in size from about 0.1 μm to about 500 μm; and in still one or more other embodiment, the ceramic particles can range in size from about 1.0 μm to about 100 μm. Non-limiting examples of ceramics include oxides, nitrides, borides, and carbides such as semi-metal elements such as B, Si, Ge, Sb, and Bi, Mg, Ca, Sr, Ba, Zn, Al, Ga, In, Sn, and Pb; transition metal elements such as Sc, Y, Ti, Zr, Hf, V, Nb, Ta, Cr, Mo, W, Mn, Fe, Co, Ni, Cu, Ag, and Au; and lanthanides such as La, Ce, Pr, Nd, Sm, Er, Lu.

The term “metal particles” generally refers to particles of an individual metal that can be selective laser melt AM processed. In one or more embodiments, the metal particles can range in size from about 1 μm to about 5000 μm; in one or more other embodiments, the ceramic particles can range in size from about 5 μm to about 1000 μm; and in still one or more other embodiment, the ceramic particles can range in size from about 10 μm to about 300 μm. The particular metal is not intended to be limited and can be an alkali metal, alkaline earth metal, transition metal, a rare earth metal or combination thereof. Non-limiting examples of metallic materials include aluminum and its alloys, titanium and its alloys, nickel and its alloys, chromium-based alloys, stainless or chrome steels, copper alloys, cobalt-chrome alloys, tantalum, niobium, iron-based alloys, combinations thereof, and the like.

The one or more metals define a metal matrix and have a larger volume ratio relative to the volume of the ceramic particles. In one or more embodiments, the volume percentage of the ceramic particles in the powder is greater than about 0 to about 80%; in one or more other embodiments, the volume percentage of the ceramic particles is from about 0.5% to about 40%; and in still one or more other embodiments, the ceramic particles can range in size from about 2% to about 30%, wherein the volume percentage is based on the total volume of the metal and ceramic particles. The upper limits generally depend on the composition and intended application.

For the purposes of the description hereinafter, the terms “upper”, “lower”, “top”, “bottom”, “left,” and “right,” and derivatives thereof shall relate to the described structures, as they are oriented in the drawing figures. The same numbers in the various figures can refer to the same structural component or part thereof. Additionally, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

Spatially relative terms, e.g., “beneath,” “below,” “lower,” “above,” “upper,” and the like, can be used herein for ease of description to describe one element or feature's relationship to another element(s) or feature(s) as illustrated in the figures.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like.

It will also be understood that when an element, such as a layer, region, or substrate is referred to as being “on” or “over” another element, it can be directly on the other element or intervening elements can also be present. In contrast, when an element is referred to as being “directly on” or “directly over” another element, there are no intervening elements present, and the element is in contact with another element.

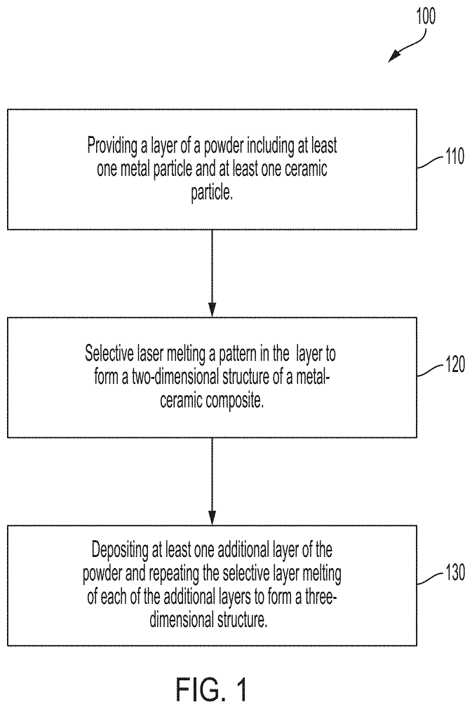

Turning now to FIG. 1, there is shown a flowchart of an exemplary selective melting AM process 100 suitable for processing a powder bed in accordance with the present disclosure including particles of one or more metals and particles of one or more ceramic materials. The selective melting AM process is not intended to be limited and may include additional steps, which are not explicitly explained.

In step 110, a first powder layer including particles of the one or more metals and particles of the one or more ceramic materials is first provided on a suitable support. The first powder layer can be obtained by combining or mixing particles of the one or more metals and the one or more ceramic materials. In one or more embodiments, the particles of the one or more ceramic materials are uniformly dispersed throughout the powder bed. For example, the particles of the one or more metals and the one or more ceramic materials can be mixed together in a blender or mixer to provide a uniform mixture. In other embodiments, the powder bed can include different particle concentrations of the one or more ceramic materials within the layer.

In step 120, the layer is subjected to a selective melting AM process using a laser energy beam (or E-beam) to selectively melt a pattern in the powder layer followed by solidifying upon cooling to define a two-dimensional solidified image in the layer. The selective melting AM process generally includes exposing the powder layer to an incident energy beam, e.g., laser energy, e-beam energy, or the like, at an energy sufficient to reactively melt the pattern in the powder layer. The energy beam can be caused to move over the layer in a desired pattern to form a reacted portion of the layer and define the two-dimensional patterned image in the layer. The selective melting AM process can be conducted in an inert atmosphere, under vacuum, or under a partial vacuum.

In the case of an applied laser energy beam, the laser energy beam can be pulsed or continuous. Exemplary gas lasers suitable for use in the selective laser melting AM process can include a helium-neon laser, argon laser, krypton laser, xenon ion laser, nitrogen laser, carbon dioxide laser, carbon monoxide laser or excimer laser. Exemplary chemical lasers can include lasers such as a hydrogen fluoride laser, deuterium fluoride laser, COIL (chemical oxygen-iodine laser), or Agil (all gas-phase iodine laser). Exemplary metal vapor lasers can include a helium-cadmium (HeCd) metal-vapor laser, helium-mercury (HeHg) metal-vapor laser, helium-selenium (HeSe) metal-vapor laser, helium-silver (HeAg) metal-vapor laser, strontium vapor laser, neon-copper (NeCu) metal-vapor laser, copper vapor laser, gold vapor laser, or manganese (Mn/MnCl₂) vapor laser. Exemplary solid state lasers include lasers such as a ruby laser, Nd:YAG laser, NdCrYAG laser, Er:YAG laser, neodymium YLF (Nd:YLF) solid-state laser, neodymium doped yttrium orthovanadate(Nd:YVO₄) laser, neodymium doped yttrium calcium oxoborate. Nd:YCa₄O(BO₃)³ or simply Nd:YCOB, neodymium glass (Nd:Glass) laser, titanium sapphire (Ti:sapphire) laser, thulium YAG (Tm:YAG) laser, ytterbium YAG (Yb:YAG) laser, ytterbium:2O₃ (glass or ceramics) laser, ytterbium doped glass laser (rod, plate/chip, and fiber), holmium YAG (Ho:YAG) laser, chromium ZnSe (Cr:ZnSe) laser, cerium doped lithium strontium (or calcium)aluminum fluoride (Ce:LiSAF, Ce:LiCAF), promethium 147 doped phosphate glass (147Pm⁺³:Glass) solid-state laser, chromium doped chrysoberyl (alexandrite) laser, erbium doped and erbium-ytterbium co-doped glass lasers, trivalent uranium doped calcium fluoride (U:CaF₂) solid-state laser, divalent samarium doped calcium fluoride (Sm:CaF₂) laser, or F-center laser. Exemplary semiconductor lasers can include laser medium types such as GaN, InGaN, AlGaInP, AlGaAs, InGaAsP, GaInP, InGaAs, InGaAsO, GaInAsSb, lead salt, Vertical cavity surface emitting laser (VCSEL), quantum cascade laser, hybrid silicon laser, or combinations thereof. For example, in one embodiment a single Nd:YAG q-switched laser can be used in conjunction with multiple semiconductor lasers. In other embodiments, E-beam can be used to cause the phase change in the metal-ceramic powder bed. In still other embodiments, E-beam can be used in conjunction with an ultraviolet semiconductor laser array. In yet other embodiments, a two-dimensional array of lasers can be used. In some embodiments with multiple energy sources, pre-patterning of an energy beam can be done by selectively activating and deactivating energy sources.

In the various commercially available additive manufacturing systems, the parameters defining the energy beam can vary widely. Generally, the power of selective laser melting additive manufacturing systems can be adjusted from about 10 to about 5000 W and will generally depend on the type of laser, the scanning velocity (which defines the exposure time) can be adjusted from about 100 mm/s to about 10,000 mm/s, hatch spacing (i.e., distance between adjacent scan lines) can be adjusted from about 10 μm to about 5000 μm, the energy density can range from about 10 J/mm³ to 10,000 J/mm³, the point distance can be in a range of about 10 μm to about 5000 μm, and layer thickness can be adjusted from about 10 μm to about 5,000 μm.

In step 130, the selective melting AM process is repeated by depositing one or more additional powder layers onto the first layer including the patterned layer and subjecting each additional patterned powder layer to the selective laser melting AM process to sequentially build the three-dimensional structure layer-by-layer. Typically, the patterns in the various layers defining the three-dimensional article are fabricated using a computer aided design (CAD) model.

Detailed embodiments of methods for forming the three-dimensional articles via selective laser melting AM processes and the resulting three-dimensional articles according to aspects of the present invention will now be described herein. However, it is to be understood that the embodiments of the invention described herein are merely illustrative of the process and structures that can be embodied in various forms. For example, as noted above, the selective melting AM processes can use E-beam to cause the phase change in the metal-ceramic powder bed. In addition, each of the examples given in connection with the various embodiments of the invention is intended to be illustrative, and not restrictive. Further, the figures are not necessarily to scale, some features can be exaggerated to show details of particular components. Therefore, specific structural and functional details described herein are not to be interpreted as limiting, but merely as a representative basis for teaching one skilled in the art to variously employ the methods and structures of the present description.

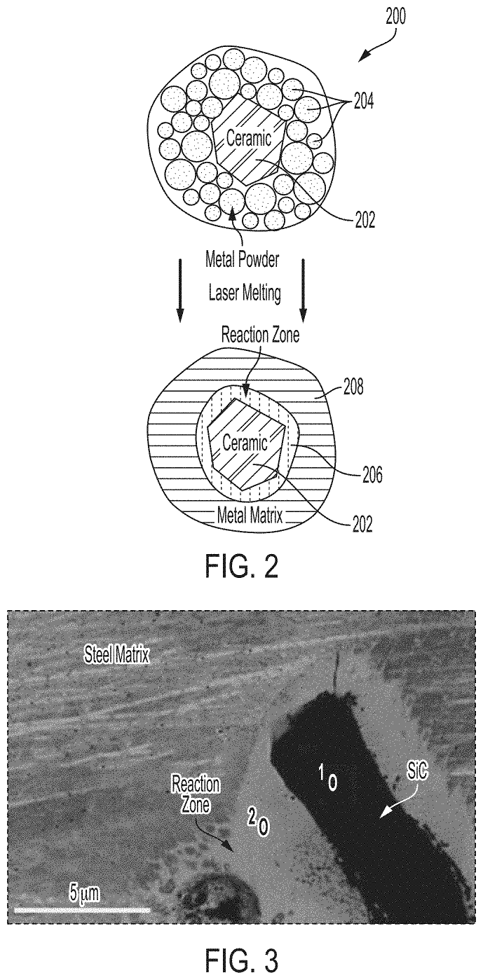

As noted above, in one or more embodiments, the selective laser melting AM process of a powder bed including ceramic particles dispersed in the metal particles matrix has been shown to increase energy transfer during the AM process. The optical properties, the thermal conductivity or a combination of the optical and thermal conductivities of the ceramic particles can be tailored in different areas within a given layer to change the energy absorption of the laser energy beam in the different areas. In this manner, ceramic reinforcement into metallic builds through reactive chemistry can produce crystalline structures and/or gradient materials that significantly improve performance of the three-dimensional structure including, but not limited to, increase in yield strength and tensile strength at room temperature and above while maintaining ductility, increase in creep resistance at higher temperatures compared to conventional alloys, increase in fatigue strength, improvement of thermal shock resistance, improvement of corrosion resistance, increases in Young's modulus, reduction of thermal elongation, among others. FIGS. 2 and 3 schematically illustrate the powder bed before and after selective laser melt AM processing formation. The powder bed 200 includes ceramic particles 202, one of which is shown for illustrative purposes, dispersed within a matrix of metal particles 204. Selective laser melt AM processing results in formation of a reaction zone 206 within a metal matrix 208 about the ceramic particle 202. The ceramic particle is not co-located within the reaction zone indicating that the ceramic material is decomposed upon selective laser melt AM processing. In practice, the ceramic particle is typically consumed in the reaction leaving the melted and solidified two-dimensional patterned image with a plurality of reaction zones within the metal build.

FIG. 3 is a scanning electron micrograph depicting a cross section of a MMC-type 316L steel produced by selective laser melt AM processing that included a silicon carbide ceramic dispersed phase. In this example, the metal powder bed included a metal particle composition of less than 0.03% carbon, 16 to 18.5% chromium, 10 to 14% nickel, 2 to 3% molybdenum, less than 1% manganese, less than 1% silicon, less than 0.045% phosphorous, and less than 0.03% sulfur with the balance being iron. The silicon carbide (SiC) particles were uniformly dispersed in the powder bed at a concentration of 5%. The SiC particles had an average particle size of about 15 to about 20 um and an aspect ratio of less than about 3 to 1.

The resulting MMC structure (MMC-type 316L steel) as shown in the micrograph of FIG. 3 was uniquely reinforced with the embedded SiC reinforcement in the metal build, which is not possible using solid state or liquified state manufacturing techniques. Table 1 illustrates the atomic percentages of the various elements using energy dispersive X-ray spectroscopy (EDS) at location 1 (i.e., silicon carbide particle) and at location 2 within the reaction zone.

TABLE 1

| | Location | |
|---|---|---|
| Atomic % | 1 | 2 |
| C | 61.0 | 28.7 |
| Si | 37.9 | 10.5 |
| Cr | 0.0 | 11.9 |
| Fe | 0.0 | 40.1 |
| Ni | 0.0 | 7.4 |
| Mo | 0.0 | 0.9 |

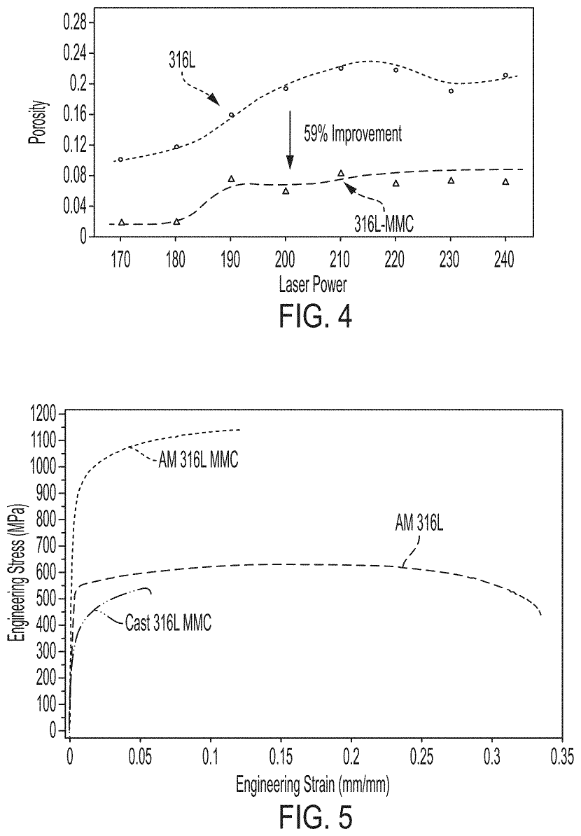

As graphically shown in FIGS. 4 and 5, a comparison of the type 316L steel composition without ceramic reinforcement and the resulting MMC structure (i.e., MMC-type 316L steel) produced using selective laser melt AM processing in accordance with the present disclosure clearly demonstrated significant improvements in properties of the MMC-type 316L steel. In FIG. 4, porosity in the MMC-type 316L steel was significantly and advantageously reduced relative to the type 316L steel formed without the ceramic reinforcement. A 59% improvement, i.e., reduction in porosity, was observed.

In FIG. 5, strain as a function of stress was measured for a cast MMC type-316L steel, and the selective laser additive manufactured MMC-type 316L steel and the type 316L steel formed without the ceramic particles. The cast MMC type-316L steel was formed by melting a powder feedstock that included 5% SiC followed by cooling until solidified. Relative to AM processing, the casting process generally has a slower heating and cooling rate as well as a different mechanism to how the energy is transmitted. A load was applied to coupons of the different steels and deformation measured under quasi static load conditions until failure.

As shown, the cast MMC type 316L steel relative to the additive manufactured type 316L steels exhibited significantly poor mechanical performance even when compared to the AM processed type-316L steel without ceramic reinforcement. As for the comparison between the AM type-316L with and without ceramic reinforcement, deformation of the AM processed MMC-type 316L steel was significantly less than that of the AM processed type 316L steel, i.e., about a 200 percent difference in stress compared to the type 316L steel. Clearly, strength properties such as Young's modulus, yield strength and ultimate tensile strength were markedly improved by AM processing of the type-316L with the addition of the ceramic particles when compared to the same composition without the ceramic particles, e.g., AM processed MMC-type 316L steel composition relative to the AM processed type-316L steel formed without the ceramic particles. Moreover, the increase in strength was obtained while maintaining ductility properties. Clearly, the use of selective laser additive manufacturing provides a significant advantage compared to convention casting and has the added benefit with formation of complex geometries unlike conventional casting methods. Moreover, a significant increase in mechanical properties can be provided with ceramic reinforcement.

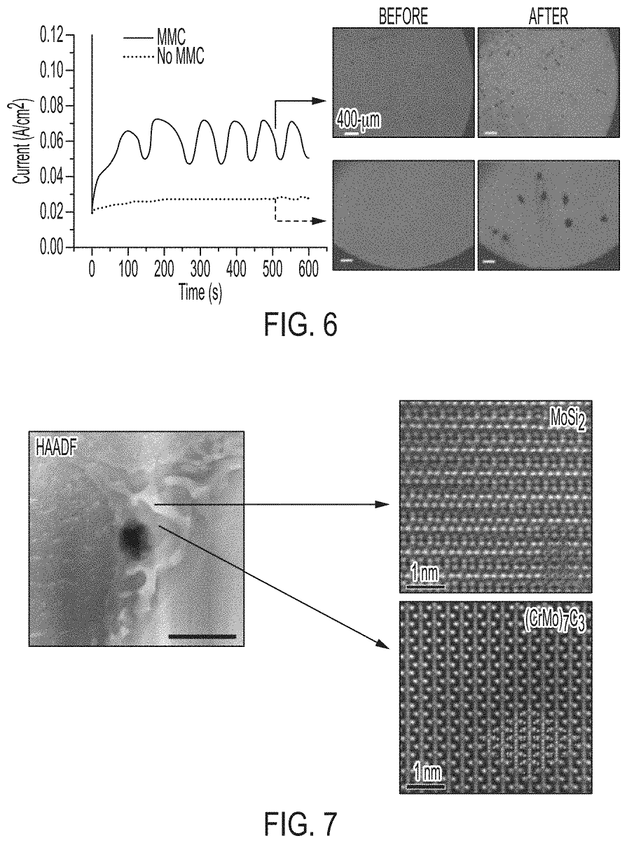

In FIG. 6, there is graphically shown current induced by an electrochemical potential applied to a MMC type 316L steel and a type 316L steel within ceramic reinforcement formed by selective laser AM processing as a function of time using a potential pulse-and-hold technique, which is indicative of corrosion performance. Additionally, micrographs of the coupon surface are depicted before and after application of the current. As shown, there was a marked decrease in pitting and crevice corrosion with a concomitant increase in the anodic oxidation-induced uniform dissolution of the MMC-type 316L steel relative to the type 316L steel formed by the selective laser melting AM process without the ceramic particles. Corrosion for the MMC-type 316L steel was minimal and uniform across the surface. In contrast, significant surface pitting and crevice formation was non-uniformly observed for the type 316L steel.

It has been found that the interface. i.e., cell boundaries, includes sub-cellular networks within the reaction zone, which is believed to result in stabilization of the grain boundaries within the metal build resulting in the improved performance, wherein the ceramic material is not co-located within the cell boundaries. In the scanning electron micrographs illustrated in FIG. 7 (gratuitously provided by Kevin Hemker and Mo Rigen of the Department of Mechanical Engineering at Johns Hopkins University), elemental analysis of the reaction zone in the MMC-type 316L steel indicates that the sub-grain boundary phase is inhomogeneous with all elements present, wherein the carbide ((CrMo)₇C₃) and silicide (Mo—Si₂) coexist as precipitates. Advantageously, the presence of the silicide provides increased corrosion performance whereas the presence of the carbide provides increased strength.

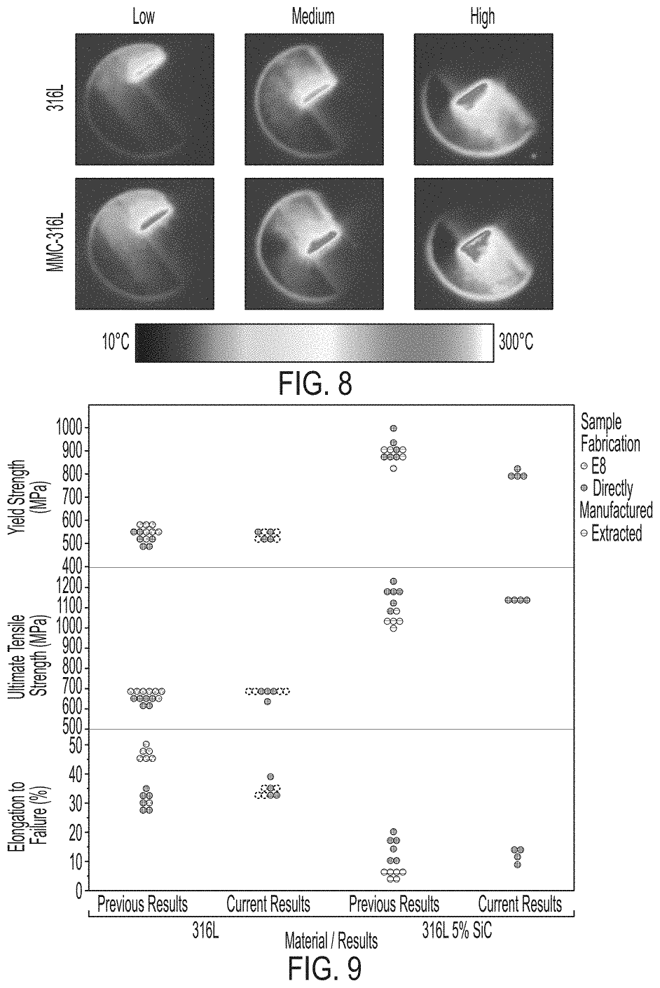

In FIG. 8, in situ thermal analysis was used to measure and quantify the energy balance for a type 316L steel and a MMC-316L steel with silicon carbide fabricated using a selective laser melt AM process including the following laser parameters provided in Table 2. The samples are characterized as low, medium, and high, which indicates the relative amount of laser energy incident on the powder bed during the selective laser melt AM process.

TABLE 2

| | Power | Velocity | Hatch | Layer | VED |
|---|---|---|---|---|---|
| Sample | (W) | (mm/s) | (μm) | (μm) | (J/mm²) |
| Low | 155 | 1280 | 90 | 20 | 67.3 |
| Medium | 195 | 1083 | 90 | 20 | 100.0 |
| High | 255 | 880 | 90 | 20 | 161.0 |

As shown in FIG. 8, a higher thermal signature was observed for the MMC-type 316L steel compared to the type 316L steel fabricated without the silicon carbide for the different levels of incident laser energy. The higher thermal signature indicates an increase in energy absorption or energy generated upon laser energy exposure for a given laser parameter, i.e., for a given laser input, the maximum thermal energy increased for the MMC type 316L compared to the type 316L without ceramic reinforcement. Moreover, as shown in the sample labelled as high, extended time at temperature indicated a slower energy release. It is also noted that the thermal profile was more uniform for the MMC-type 316L steel than the type 316L steel fabricated without the silicon carbide.

FIG. 9 graphically illustrates a comparison of type 316L steel fabricated without ceramic reinforcement and the MMC-type 316L steel with ceramic reinforcement for different strength properties. Multiple coupons of each steel were fabricated using the selective laser melt AM process and tensile properties such as elongation percentage, ultimate tensile strength, and yield strength were subsequently measured. As shown, ultimate tensile strength and yield strength advantageously increased for the MMC-type 316L steel compared to the type 316L steel fabricated without the silicon carbide. Additionally, elongation percentage advantageously decreased for the MMC-type 316L steel compared to the type 316L steel fabricated without the silicon carbide.

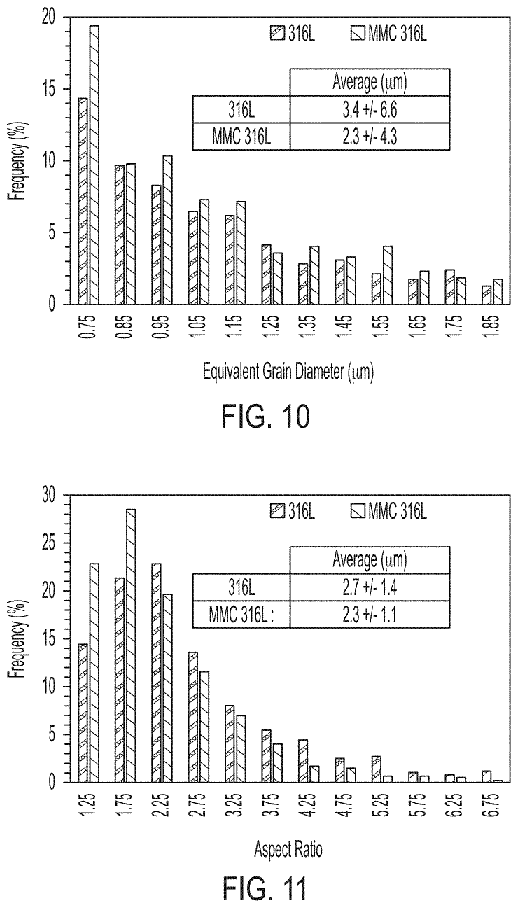

It has also been discovered that grain size decreased and the grains themselves became more equiaxed for the MMC metal builds such as the MMC-type 316L steel compared to the type 316L steel fabricated without the ceramic reinforcement. FIGS. 10 and 11 graphically illustrate the equivalent grain diameter and aspect ratio distribution of the grain structure, respectively, in the above noted steels. Grain boundary strengthening (i.e., Hall-Petch strengthening) was more prominently observed in the MMC-type 316L steel compared to the type 316L steel fabricated without the ceramic reinforcement. Hall-Petch estimations predict grain size of about 300 nm to result in the observed strengthening, which was found to provide a 36 MPa increase in strength (i.e., about 5% of the measured strengthening).

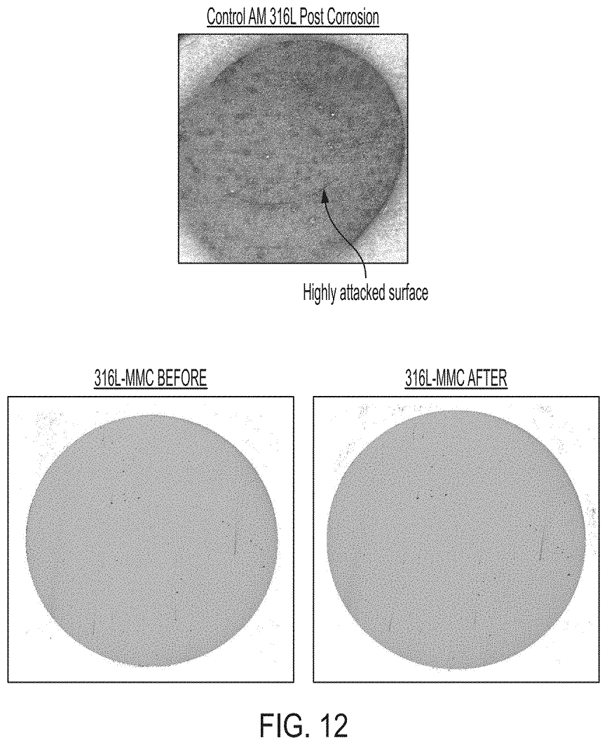

In addition to significant increases in strength for the additive manufactured MMC-type 316L steel compared to the type 316L steel fabricated without the ceramic reinforcement, corrosion resistance was markedly improved. Corrosion resistance was generally measured in accordance with ASTM G48 but modified using a 30% and a 60% by weight FeCl₃ solution to accelerate corrosion. A droplet of the FeCl₃ solution was placed on a surface of each sample and exposed for 5 minutes (30% by wt. FeCl₃ solution) or 50 minutes (60% by wt. FeCl₃ solution). It was found that surface corrosion was minimal and uniform for the MMC-type 316L steel with no evidence of pitting or crevice formation. In contrast, surface corrosion was non-uniform with clear evidence of pitting and crevice formation for the type 316L steel without ceramic reinforcement. FIG. 12 pictorially illustrates micrographs of the surface of the type 316L steel without ceramic reinforcement subsequent to exposure of the 60% FeCl₃ solution for 50 minutes, which clearly shows significant corrosion. In contrast, the before and after images of the MMC-type 316L steel subsequent to exposure of the 60% FeCl₃ solution for 50 minutes were substantially the same indicating high resistance to corrosion.

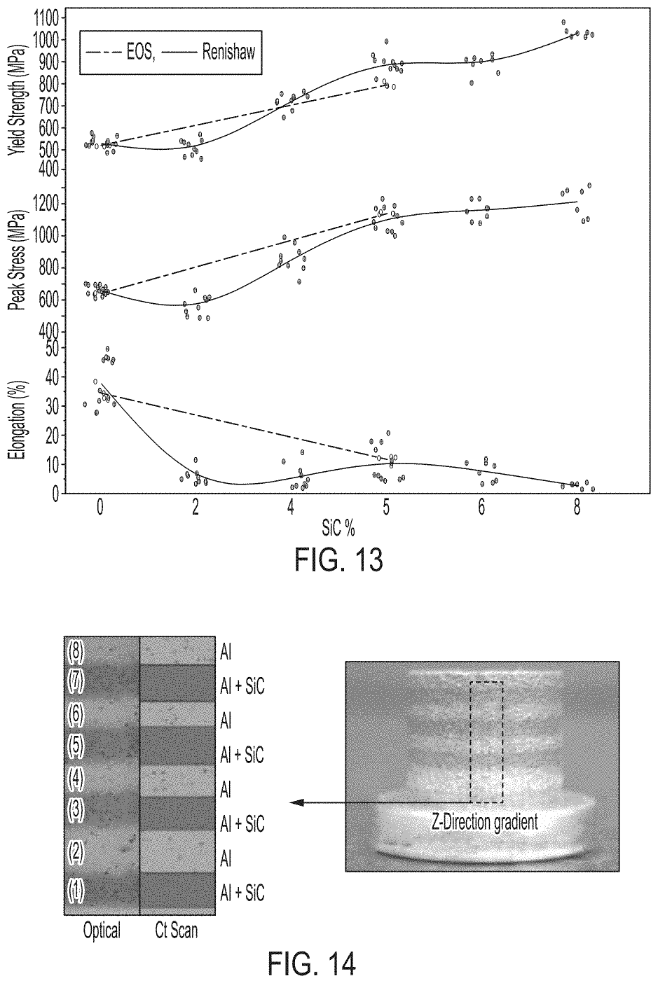

As noted above, the laser utilized in the selective laser melting AM process can be pulsed or continuous. Similar strengthening effects have been observed for the different types of lasers. FIG. 13 graphically illustrates various strength properties of a MMC-type 316L steel as a function of % by weight silicon carbide that were additively manufactured using a pulsed-type laser three-dimensional printer commercially available under the tradename Renishaw™ and a continuous-type laser three-dimensional printer commercially available under the tradename EOS™. As shown, similar strengthening effects such as elongation percentage, yield strength, and stress were observed for the three-dimensional printers including the pulsed laser and the continuous laser.

FIG. 14 illustrates an aluminum metal build including 8 alternating layers of aluminum (Al) and aluminum reinforced with silicon carbide (Al+SiC) to produce a z-direction gradient by a selective laser melt AM process. Each layer in the powder bed included aluminum metal particles or aluminum metal particles and silicon carbide particles to produce the z-direction gradient metal build of Al and MMC-Al layers. The metal build was then subjected to a Vickers Hardness Test and percent porosity defined by the gradient zones illustrated in FIG. 14. The Vickers Hardness test consists of applying a force, i.e., a load, on the test material using a diamond indenter, to obtain an indentation. The depth of indentation on the material gives the value of hardness for the specimen. In general, the smaller the indentation, the harder the object.

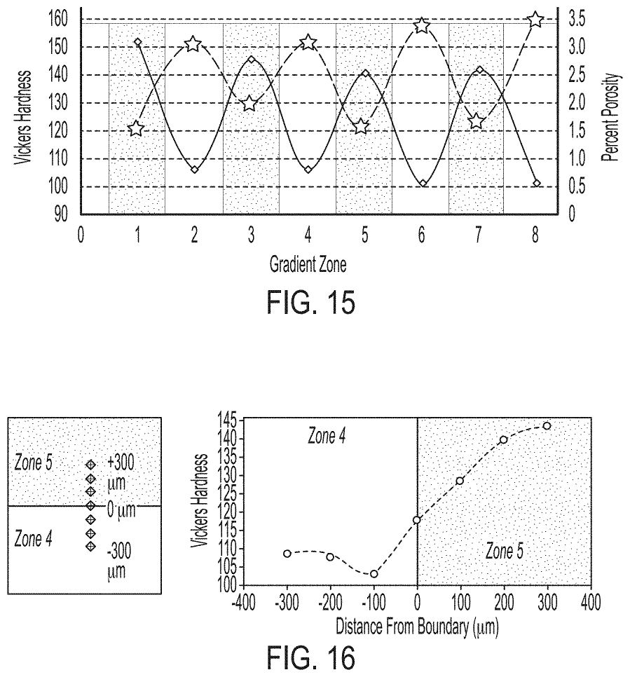

FIG. 15 graphically illustrates a sinusoidal relationship for the hardness values (e.g., Vickers Hardness) and the percent porosity. Hardness increased in the MMC—Al layer compared to the Al layer and percent porosity was significantly decreased in the MMC—Al layer compared to the Al layer. Moreover, as shown in FIG. 16, the hardness value changed as a function of distance from the boundary between the different zones (zone 4 was Al and zone 5 was MMC-Al), which demonstrates changes in crystallinity extending from the boundary into both zones. The dip shown in Zone 4 at about 100 μm from the boundary can be attributed to the lower density of the ceramic particles, which advantageously provides a relatively smooth transition in stiffness to minimize propensity of failure at the boundary.

Advantageously, MMCs formed by selective laser melt AM processing of powder beds including metal particles of one or more metals and ceramic particles of one or more ceramic materials provide a unique class of materials because their physical and mechanical properties can be dramatically tailored depending on the relative volume fraction of the metal and ceramic phases. MMC metal builds exhibit exceptional strength and corrosion performance that was not previously obtainable.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

What is claimed is:

1. An additive manufacturing process for producing a three-dimensional article comprising:
providing a layer of feedstock comprising a plurality of metallic particles of one or more metals and a plurality of ceramic particles of one or more ceramic materials;
exposing the layer of the feedstock to an energy beam in a pattern to form a metal-ceramic composite in the pattern, wherein forming the metal-ceramic composite comprises tailoring optical properties of the feedstock in different areas within the layer to change energy absorption of the energy beam by the feedstock in the different areas;
depositing at least one additional layer of the feedstock; and
repeating the exposing on the at least one additional layer to form the three-dimensional article.

2. The additive manufacturing process of claim 1, wherein tailoring the optical properties comprises generating at least one of an exothermic reaction or an endothermic reaction between the metallic particles and the ceramic particles in the different areas, wherein the ceramic particles or the metallic particles or combinations thereof are selected to absorb energy from the energy beam or reflect energy from the energy beam or a combination of absorb and reflect the energy.

3. The additive manufacturing process of claim 1, wherein forming the metal-ceramic composite forms sub-cellular networks including cell boundaries comprising a reaction byproduct between the one or more metals and the one or more ceramic materials, wherein the ceramic material is not co-located within the cell boundaries and is selected to absorb energy from the energy beam at an amount greater than the one or more metals.

4. The additive manufacturing process of claim 1, further comprising tailoring the optical properties by modifying the ceramic particles, changing an amount of the ceramic particles, or a combination of modifying the ceramic particles and changing the amount of the ceramic particles within the feedstock to change energy absorption of the energy beam.

5. The additive manufacturing process of claim 4, wherein modifying the ceramic particles comprises providing the ceramic material with a different oxidation state.

6. The additive manufacturing process of claim 1, wherein the energy beam is a continuous laser beam.

7. The additive manufacturing process of claim 1, wherein the energy beam is a pulsed laser beam.

8. The additive manufacturing process of claim 1, wherein the energy beam is an electron beam.

9. The additive manufacturing process of claim 1, wherein the one or more metals comprise at least molybdenum and chromium and the one or more ceramic materials comprise silicon carbide, and wherein the reaction byproduct is selected from a group consisting of MoSi₂, (CrMo)₇C₃ and combinations thereof.

10. The additive manufacturing process of claim 1, wherein the metal matrix composite comprises an austenitic steel.

11. The additive manufacturing process of claim 1, wherein the metal matrix composite has increased resistance to pitting and crevice corrosion relative to the metal matrix composite without the sub-cellular network.

12. The additive manufacturing process of claim 1, wherein the sub-cellular networks comprise compounds different from the one or more ceramic materials, wherein the compounds comprise nitrides, borides, carbides, oxides, silicides or combinations thereof.

13. The additive manufacturing process of claim 1, wherein the metal matrix composite has increased strength relative to the metal matrix composite without the sub-cellular network.

14. The additive manufacturing process of claim 1, wherein the metal-ceramic composite comprises a reaction zone about the ceramic particle, wherein the reaction zone comprises a sub-cellular network.

15. The additive manufacturing process of claim 1, wherein the metal-ceramic composite is formed from one or more metals defining a type 316L steel and silicon carbide.

16. An additive manufacturing process for producing a three-dimensional article comprising:
providing a layer of feedstock comprising a plurality of metallic particles of one or more metals and a plurality of ceramic particles of one or more ceramic materials;
exposing the layer of the feedstock to an energy beam in a pattern to form a metal-ceramic composite in the pattern, wherein forming the metal-ceramic composite comprises tailoring heat flow in different areas of the layer by changing thermal conductivity of the ceramic particles therein to enable an increase or a decrease in a cooling rate in the different areas;
depositing at least one additional layer of the feedstock; and
repeating the exposing on the at least one additional layer to form the three-dimensional article.

17. The additive manufacturing process of claim 16, wherein the ceramic particles are selected to provide heat release upon exposure to the energy beam.

18. The additive manufacturing process of claim 16, wherein the ceramic particles are selected to absorb energy from the energy beam at an amount greater than the one or more metals and provide heat release upon exposure to the energy beam.

19. The additive manufacturing process of claim 16, wherein the thermal conductivity is selected to reduce porosity in the metal matrix composite.

20. The additive manufacturing process of claim 16, wherein the energy beam is continuous laser beam.

21. The additive manufacturing process of claim 16, wherein the energy beam is pulsed laser beam.

22. The additive manufacturing process of claim 16, wherein the energy beam is an electron beam.

23. The additive manufacturing process of claim 16, wherein the metal-ceramic composite comprises a reaction zone about the ceramic particle, wherein the reaction zone comprises a sub-cellular network.

24. The additive manufacturing process of claim 16, wherein the metal-ceramic composite is formed from one or more metals defining a type 316L steel and silicon carbide.

25. A metal-ceramic matrix composite comprising:
a metal;
a ceramic; and
a reaction zone between the metal and a ceramic particle, wherein the reaction zone comprises nitrides, borides, carbides, oxides, silicides or combinations thereof of the metal having a different composition than the ceramic.

26. The metal-ceramic matrix composite of claim 25, wherein the reaction zone a reaction product selected from a group consisting of a MoSi₂ precipitate, a (CrMo)₇C₃ precipitate, and a combination thereof.

27. The metal-ceramic matrix composite of claim 25, wherein the metal matrix composite is an austenitic steel.

28. The metal-ceramic matrix composite of claim 25, wherein the reaction zone comprises grains smaller than grains outside the reaction zone.
